(19) United States
(12) Patent Application Publication
(10) Pub. No.: US 2023/0124657 A1
(43) Pub. Date: Apr. 20, 2023

(54) EGR Powered System and Energy Provider Billing Entity, Billing Management Using Blockchain

(71) Applicant: Allan Jerome, West Bloomfield, MI (US)

(72) Inventor: Allan Jerome, West Bloomfield, MI (US)

(21) Appl. No.: 17/967,899

(22) Filed: Oct. 18, 2022

Related U.S. Application Data
(60) Provisional application No. 63/257,092, filed on Oct. 18, 2021.

(51) Int. Cl. G06Q 20/36; G06Q 20/14

(52) U.S. Cl. CPC G06Q 20/3678; G06Q 20/145

(57) ABSTRACT

EGR powered systems that generate power may be individually and uniquely associated with a blockchain wallet into which funds may be transferred. The EGR powered system can be provided with a client application that executes within the EGR powered system to determine an Energy Provider Billing Entity and the cost rate of energy supply. The client application calculates a value of energy generation by the EGR powered system and creates a blockchain transaction to transfer a funds value for the energy generation from the EGR powered system's blockchain wallet to a wallet of the Energy Provider Billing Entity when the EGR powered system is generating power to a load. Conversely, the client application calculates a value of energy generation by the EGR powered system and creates a blockchain transaction to transfer a funds value for the energy generation from the Energy Provider Billing Entity's blockchain wallet to a wallet of the EGR powered system when the EGR powered system is generating power to the power Grid

By providing EGR powered systems that can self-manage their electricity, thermal, and photon energy supply and the accounting thereof, billing of power can be decentralized from a meter that meters all supply to individual EGR powered systems. The requirement for a central billing entity, billing address, etc. can also be removed.

### CROSS-REFERENCE TO RELATED APPLICATIONS

This application claims the benefit of prior filed U.S. Provisional Application No. 63/257,092 filed on Oct. 18, 2021, which is hereby incorporated by reference in its entirety.

### TECHNICAL FIELD

This application generally relates to managing the power generation of one or more EGR powered systems, and more particularly, to accounting for energy generation by EGR powered systems using a blockchain network and method of payment to an Energy Provider Billing Entity

### BACKGROUND

In the USA, independent system operators (ISOs) and regional transmission organizations (RTOs) use bid-based markets to determine economic dispatch of energy.

In Europe Transmission System Operator (TSO) use bid-based markets to determine economic dispatch of energy. In other parts of the world similar operators exist.

The end goal of these organizations is to match power generator capacity vs power demand by users to foster competition for electricity generation among, wholesale market participants.

In the invention, ISOs, RTOs, TSOs, and other wholesale market dispatch organizations or operators will be referred to as Transmission System Operators. The term “Transmission System Operators” and the term “Buyer” may be used interchangeably throughout the entire document.

Distributed energy resources (DERs) are small-scale power generation or storage technologies (typically from 1 kW to 10,000 kW) that can provide an alternative to or an enhancement of the traditional electric power system. These can be located on an electric utility's distribution system, a subsystem of the utility's distribution system or behind a customer meter. They may include electric storage, intermittent generation, distributed generation, demand response, energy efficiency, thermal storage or electric vehicles and their charging equipment.

Recently government regulators in the US established Order No. 2222 Sep. 28, 2020.

This rule enables DERs to participate alongside traditional resources in the regional organized wholesale markets through aggregations, opening U.S. organized wholesale markets to new sources of energy and grid services. This would help provide a variety of benefits including: lower costs for consumers through enhanced competition, more grid flexibility and resilience, and more innovation within the electric power industry.

This rule allows several sources of distributed electricity to aggregate in order to satisfy minimum size and performance requirements that each may not be able to meet individually.

Regional Buyers (i.e., Transmission system operators) are required to revise their tariffs to establish DERs as a category of market participant. These tariffs will allow the aggregators to register their resources under one or more participation models that accommodate(s) the physical and operational characteristics of those resources.

In this invention one such Aggregator is an Energy Provider Billing Entity which allows EGR powered systems which provide distributed electricity, to be aggregated, in order to satisfy minimum size and performance requirements that each may not be able to meet individually. EGR powered systems may be aggregated to dispatch energy under the control of Dynamic virtual power plants (DVPPs). Energy Provider Billing Entities act on behalf of EGR powered systems owners/operators to transact energy sales with Transmission System Operators. When a request to generate energy is received by the Energy Provider Billing Entities from a Transmission System Operator, the Energy Provider Billing Entity utilizes a DVPP to co-ordinate with available EGR Powered System participants to dispatch the energy to the power grid. If available to do so, then the Energy Provider Billing Entities generates a contract with Transmission System Operator to deliver the requested energy quantity on a scheduled basis.

A ledger is commonly defined as an account book of entry, in which transactions are recorded. A distributed ledger is ledger that is replicated in whole or in part to multiple computers. A Cryptographic Distributed Ledger (CDL) can have at least some of these properties: irreversibility (once a transaction is recorded, it cannot be reversed), accessibility (any party can access the CDL in whole or in part), chronological and time-stamped (all parties know when a transaction was added to the ledger), consensus based (a transaction is added only if it is approved, typically unanimously, by parties on the network), verifiability (all transactions can be cryptographically verified). A blockchain is an example of a CDL. While the description and figures herein are described in terms of a blockchain, the instant application applies equally to any CDL.

A distributed ledger is a continuously growing list of records that typically apply cryptographic techniques such as storing cryptographic hashes relating to other blocks. A blockchain is one common instance of a distributed ledger and may be used as a public ledger to store information. Although, primarily used for financial transactions, a blockchain can store various information related to goods and services (i.e., products, packages, status, etc.). A decentralized scheme provides authority and trust to a decentralized network and enables its nodes to continuously and sequentially record their transactions on a public “block”, creating a unique “chain” referred to as a blockchain. Cryptography, via hash codes, is used to secure an authentication of a transaction source and removes a central intermediary. Blockchain is a distributed database that maintains a continuously-growing list of records in the blockchain blocks, which are secured from tampering and revision due to their immutable properties. Each block contains a timestamp and a link to a previous block. Blockchain can be used to hold, track, transfer and verify information. Since blockchain is a distributed system, before adding a transaction to the blockchain ledger, all peers need to reach a consensus status.

Blockchain technology can be used as a payment system for virtually any commodity. Each user and merchant that wishes to transact on the blockchain, may maintain a blockchain wallet. Funds can be transferred into the wallet by the wallet owner/operator. Funds can then be transferred between wallets in payment for goods and services. All transactions can be registered on the blockchain, thereby providing a secure, immutable record of the transfer. In addition, the transaction can be governed by a smart contract (self-executing contract) or similar record that specifies various aspects of the transaction, such as timing of the payment, conditions of payment, conditions of service, etc. Currently the financial process between an energy provider and a consumer has to pass through a physical address and a bill. Bills can be electronic or come physically by mail, but a bill is linked to an address and a person or provider company responsible for the account.

It is somewhat limiting in that in order to consume energy today an account has to be created by a person or company with the energy provider, an address for billing and energy consumption must be provided and the billing process is centralized and carried out by one specific party. Validations of consumption are all done by the energy provider, usually manually by an employee reading the electric meter of every house every month. This is a very costly and error prone approach, besides the absence of separate unbiased parties to confirm the amount consumed at the time of the billing. Also, the energy is provided without any guarantee that the consumer will have funds at the time of the billing.

What is required is a system and method for accounting for energy generation by owners/operators of EGR powered systems without having to pass through a physical address and a bill for payment to the Energy Provider

### SUMMARY

Most recently a new class of DER systems has been developed by the inventor called an Energy Generation Reactor Powered System. Incorporated by reference in its entirety is applicant's invention Energy Generation Reactor Powered System application Ser. No. 17/855,526 Jun. 30, 2022.

One example embodiment may provide a method that includes one or more of determining, by an EGR powered system that is mobile or stationary, and the amount of power generation and energy delivered over time by the EGR powered system. The EGR powered system may determine a value for the power generation and initiate a transfer of the value from EGR powered system wallet associated with the EGR powered system to the Energy Provider Billing Entity wallet associated with an Energy Provider Billing Entity for the power generation.

Another example embodiment may provide a stationary EGR powered system that includes one or more connectors for connecting the EGR powered system to an electrical outlet of a premises, one or more power meters that measure the amount of power generation and energy delivered over time by the of the EGR powered system, one or more processors and one or more memories operatively associated with the processor. The EGR powered system may include one or more instructions sets executable by the one or more processors that, when executed, cause the one or more processors to perform a calculation of a cost of power generation for the EGR powered system, and an initiation of a transfer of a value for the cost of power generation for the EGR powered system from EGR powered system wallet associated with the EGR powered system to the Energy Provider Billing Entity wallet associated with an Energy Provider Billing Entity.

Another example embodiment may provide a mobile EGR powered system that includes one or more power meters that measure the amount of power generation and energy delivered over time by the of the mobile EGR powered system, one or more processors and one or more memories operatively associated with the processor. The mobile EGR powered system may include one or more instructions sets executable by the one or more processors that, when executed, cause the one or more processors to perform a calculation of a cost of power generation for the mobile EGR powered system, and an initiation of a transfer of a value for the cost of power generation for the EGR powered system from mobile EGR powered system wallet associated with the mobile EGR powered system to Energy Provider Billing Entity wallet associated with an Energy Provider Billing Entity.

Another example embodiment may provide a stationary EGR powered system that includes one or more connectors for connecting the EGR powered system to an electrical outlet of a premises, one or more power meters that measure the amount of power generation and energy delivered over time by the of the EGR powered system to the power grid for sale of energy to transacted by Energy Provider Billing Entity with an transmission system operator, one or more processors and one or more memories operatively associated with the processor. The mobile or stationary EGR powered system may include one or more instructions sets executable by the one or more processors that, when executed, cause the one or more processors to perform a calculation of a cost of power generation for the mobile EGR powered system, and an initiation of a transfer of a value of power generation performed by the EGR powered system. The value of power generation performed by the EGR powered system returned back to a dynamic virtual power plant (DVPP) and Energy Provider Billing Entity. The mobile or stationary EGR powered system wallet associated with the mobile or stationary EGR powered system receiving a payment or credit from the Energy Provider Billing Entity wallet associated with an Energy Provider Billing Entity sale of power to a transmission system operator operating a portion of the grid. The process more fully disclosed in the applicant's application Ser. Nos. 17/967,894 and 17/967,896 and incorporated by reference.

A further example embodiment may provide a non-transitory computer readable medium comprising instructions, that when read by a processor, cause the processor to perform one or more of a calculation of a cost of power generation for an EGR powered system comprising one or more power generating components that generates power to perform one or more intended functions of the EGR powered system, and an initiation of a transfer of a value for the cost of power generation for the EGR powered system from EGR powered system wallet associated with the EGR powered system to an Energy Provider Billing Entity wallet associated with an Energy Provider Billing Entity.

### BRIEF DESCRIPTION OF THE DRAWINGS

FIG. 1 illustrates an example of a system with a Dynamic virtual power plant (DVPP) controlling a plurality of distributed power EGR Powered Systems according to some embodiments and Energy Provider Billing Entity for interacting with the energy wholesale markets and the EGR Powered System DERs

FIG. 2 illustrates a network diagram of a blockchain network that can be used to provided self-managing power accounting for EGR powered systems, according to example embodiments.

FIG. 3 illustrates a schematic of a power generating EGR powered system with an associated IoT and blockchain subsystem with an associated blockchain wallet, according to example embodiments.

FIG. 4 illustrates a schematic of a power generating EGR powered system illustrating power generating hardware, metering devices associated with power generating components, and a IoT and blockchain subsystem according to example embodiments.

FIG. 5A illustrates an example peer node blockchain architecture configuration for an asset sharing scenario, according to example embodiments.

FIG. 5B illustrates an example peer node blockchain configuration, according to example embodiments.

FIG. 6 is a diagram illustrating a permissioned blockchain network, according to example embodiments.

FIG. 7A, 7B illustrates a flow diagram of an example method for self-managing electricity supply and accounting by a EGR powered system, according to example embodiments.

FIG. 8 illustrates a flow diagram of an example method for managing power generation accounting on a blockchain.

FIG. 9A illustrates an example physical infrastructure configured to perform various operations on the blockchain in accordance with one or more operations described herein, according to example embodiments.

FIG. 9B illustrates an example smart contract configuration among contracting parties and an Energy Provider Billing Entity configured to enforce smart contract terms on a blockchain, according to example embodiments.

FIG. 10 illustrates an example computer system configured to support one or more of the example embodiments.

FIG. 11 illustrates a block chain that may be maintained by the nodes in the distributed peer-to-peer network and in which blocks of the blockchain may contain one or more EGR Powered System Owner/Operator—Energy Provider Billing Entity contract agreements and blocks which may contain one or more individual energy transactions or group energy transactions

FIG. 12 illustrates the EGR Powered System Owner/Operator—Energy Provider Billing Entity contract block and the Energy transaction block in more detail.

FIG. 13 illustrates in more detail the Blockchain ID that is part of the EGR Powered System Owner/Operator—Energy Provider Billing Entity contract block and the Energy transaction block illustrated in FIG. 12.

### DETAILED DESCRIPTION

It will be readily understood that the components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed, but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc.

The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

Example embodiments provide methods, EGR powered systems, networks and/or systems, which provide for the management of a EGR powered system for energy generation by applying a blockchain protocol.

A blockchain is a distributed system which includes multiple nodes that communicate with each other. A blockchain operates programs called chaincode (i.e., smart contracts, etc.), holds state and ledger data, and executes transactions. Some transactions are operations invoked on the chaincode. In general, blockchain transactions typically must be “endorsed” by certain blockchain members and only endorsed transactions may be committed to the blockchain and have an effect on the state of the blockchain. Other transactions which are not endorsed are disregarded. There may exist one or more special chaincodes for management functions and parameters, collectively called system chaincodes.

Nodes are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node which submits a transaction-invocation to an endorser (i.e., peer), and broadcasts transaction-proposals to an ordering service (i.e., ordering node). Another type of node is a peer node which can receive client submitted transactions, commit the transactions and maintain a state and a copy of the ledger of blockchain transactions. Peers can also have the role of an endorser, although it is not a requirement. An ordering-service-node or orderer is a node running the communication service for all nodes, and which implements a delivery guarantee, such as a broadcast to each of the peer nodes in the system when committing transactions and modifying a world state of the blockchain, which is another name for the initial blockchain transaction which normally includes control and setup information.

A ledger is a sequenced, tamper-resistant record of all state transitions of a blockchain. State transitions may result from chaincode invocations (i.e., transactions) submitted by participating parties (i.e., client nodes, ordering nodes, endorser nodes, peer nodes, etc.). A transaction may result in a set of asset key-value pairs being committed to the ledger as one or more operands, such as creates, updates, deletes, and the like. The ledger includes a blockchain (also referred to as a chain) which is used to store an immutable, sequenced record in blocks. The ledger also includes a state database which maintains a current state of the blockchain. There is typically one ledger per channel. Each peer node maintains a copy of the ledger for each channel of which they are a member.

A chain is a transaction log which is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys that are included in the chain transaction log. Because the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup, and before transactions are accepted.

FIG. 1 illustrates an example power system 100 according to some embodiments.

In reference to FIG. 1, there may be from 124-1 thru 124-m groups of distributed energy resources (DERs). Power system 124-1 is an example of a group of distributed energy resources (DERs), shown as EGR Powered Systems 104-1 through 104-3, that are each separately coupled to a power grid 102.

As such, power system 100 includes a plurality of EGR Powered Systems 104 (EGR Powered Systems 104-1 through 104-n are illustrated in FIG. 1. EGR Powered Systems 104-1 through 104-n may be geographically separated, and each may be associated with and may supply power directly with different residences, businesses, other establishments, transportation vehicles, industrial factories, hydrogen stations, electrical recharging stations. etc. EGR Powered Systems 104 may connect to receive power from the grid in backup mode in event EGR Powered Systems 104 are unable to generate power and/or the EGR Powered system backup power becomes depleted.

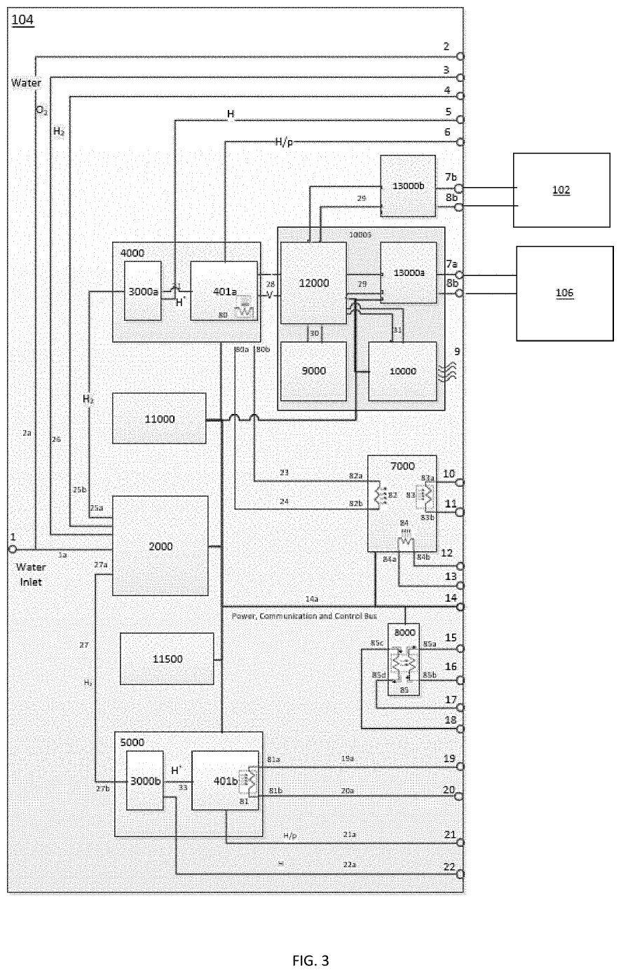

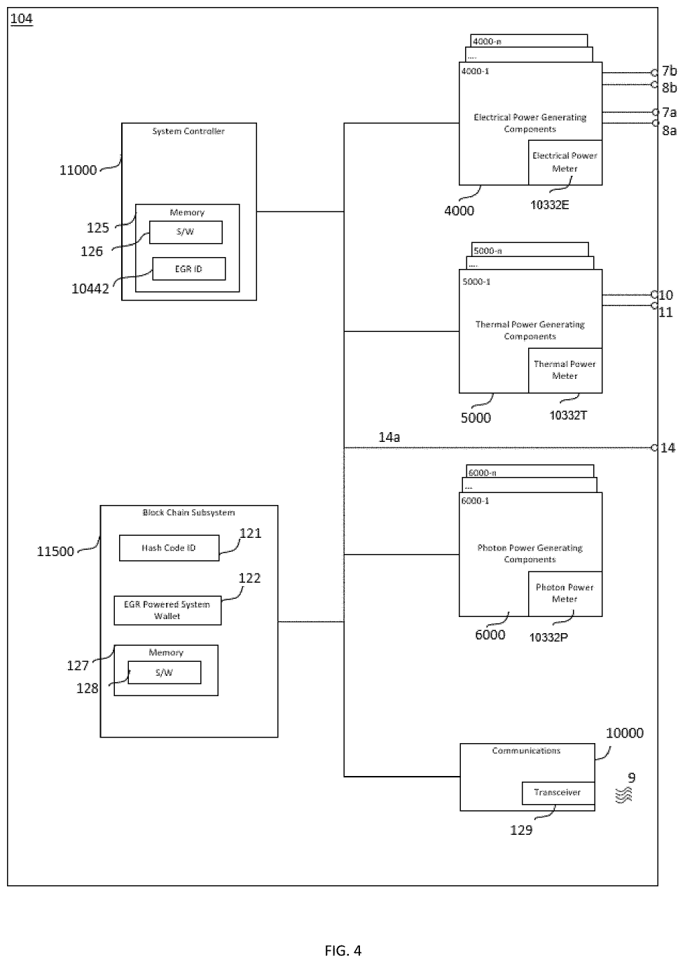

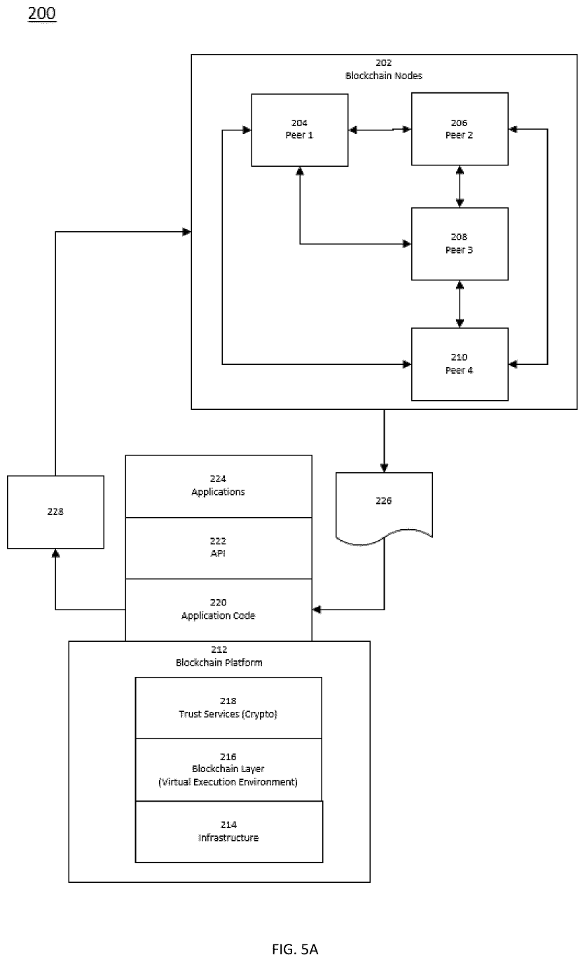

In reference to FIGS. 3 and 4, each of EGR Powered Systems 104 represents a DER that is coupled to receive and supply power to a power grid 102. EGR Powered Systems 104 can be coupled to power grid 102 and internally meter electrical power via EGR Energy Meter 10332E, and internally meter thermal power via EGR Energy Meter 10332T, or and internally meter photon power via EGR Energy Meter 10332P

EGR energy meters 10332E, 10332T, 10332P are components of EGR Powered systems designed to gather power measurements to calculate energy produced. This information is supplied back to the DVPP and/or Energy Provider Billing Entity when energy generation has been completed

In general, power grid 102 can be any power distribution system that receives power from power sources and provides power to power users.

As shown in FIG. 1, power grid 102 receives power from power sources 120 and supplies power to power users 122. There can be any number of power sources 120 coupled to power grid 102. Power users 122 can be owner/operators of industrial, commercial, residential, military, and transportation users. Power users 122 can be electric charging stations and/or fuel cell refueling stations. Such systems are designated as EGR Powered Systems 104 in FIG. 1 and may be mobile or non-mobile EGR powered systems.

Power sources 120 can be, for example, commercial power plants, EGR Powered System power generating plants, EGR Powered Systems 104, coil-fired plants, hydroelectric plants, geothermal plants, nuclear plants, gas-fired plants, solar production facilities, wind power facilities, electric charging stations and/or fuel cell refueling stations, individual generators (i.e., non-EGR powered systems) or any other power production facility for the production of power.

Furthermore, a large EGR Powered System power generation station may represent further power generation facilities 120 coupled to power grid 102.

As illustrated in FIG. 1, power grid 102 is coupled to EGR Powered Systems 104, each of which may provide power to grid 102 or receive power from grid 102.

As is illustrated in FIG. 1, EGR Powered Systems 104 can be networked by being coupled to dynamic virtual power plant 110, for example.

DVPP 110 can provide monitor and control functions to individual EGR Powered Systems 104.

As illustrated in FIG. 1, EGR Powered Systems 104-1 through 104-n are in communication with DVPP 110.

Any form of communication, including wired or wireless communications protocols, can be utilized between DVPP 110 and EGR Powered Systems 104-1 through 104-n.

In accordance with some embodiments, any number of EGR Powered Systems 104 may also be coupled to a DVPP 110. DVPP 110 may provide individual instructions to individual EGR Powered Systems 104-1 thru 104-n. In other embodiments DVPP 110 may provide individual instructions to a group of EGR Powered Systems groups 124-1 through 124-m are shown in FIG. 1.

DVPP Communication with EGR Powered Systems:

A DVPP can communicate with a single one of EGR Powered Systems 104 or may be a group that includes multiples of EGR Powered Systems 104. Groups may be formed from EGR Powered Systems 104 such as 124-1, 124-2 thru 124-m

Exemplary EGR Powered System groups are as shown in FIG. 1, EGR Powered System group 124-1 is formed by EGR Powered Systems 104-1 through 104-3; EGR Powered System group 124-2 is formed by EGR Powered System 104-4 through 104-5. EGR Powered Systems-104-6 is shown as individual EGR Powered System. There may be through 124-1 thru 124-m groups containing individual EGR Powered Systems 104.

As shown in FIG. 1, DVPP 110 is in communication with group of EGR Powered Systems 104-1 thru 104-n.

In general, a DVPP 110 can interoperate with any single one of EGR Powered Systems 104 or any of groups of EGR Powered Systems 104.

In general, DVPP 110 receives energy generation requests from Energy Provider Billing Entity 112 and, if that request can be satisfied by the resources represented by EGR Powered Systems, DVPP 110 instructs EGR Powered Systems in order to satisfy the power request.

An Energy Provider Billing Entity is an Entity that trades energy to the wholesale market on behalf of the EGR Powered systems owners/operators. Additionally, an Energy Provider Billing Entity is responsible for Billing owners/operators of EGR Powered systems and directing enablement of power generation of EGR Powered Systems operating in the market place.

Referring to FIG. 4, to facilitate communication between an EGR powered system 104, a unique EGR identifier 10422 is required. In the exemplary embodiment, unique EGR identifier 10422 is a number generated by server system upon creation of the EGR. In one embodiment, unique EGR identifier 10422 includes a manufacturer provided number of the EGR powered system 104. In other embodiments, unique EGR identifier 10422 can be one or more of an Energy Provider Billing Entity account number, a pre-paid stored value account number, or any suitable identifying number of a type known to those skilled in the art and guided by the teachings herein provided that is capable of being used as described herein. In one embodiment, unique EGR identifier 10422 is accessible only upon authorization by the owner/operator of EGR powered system 104, as to restrict unauthorized access to the unique EGR identifier 10422.

In the exemplary embodiment, a unique EGR powered system unique EGR identifier 10422 is linked in memory 125 to an account associated with the EGR of the EGR powered system 104. An account balance is maintained within memory 125 including prepayments made to the account by the account owner. Alternatively, unique EGR identifier 10422 may be linked to an account associated with a person, such that an account balance may be allocated among one or more EGR powered systems 104. Referring to FIG. 4 in an exemplary embodiment, EGR powered system 104 includes an EGR meter 10332E and 10332T or 10332P that tracks a quantity of electrical, thermal and/or photon energy generated by the EGR powered system 104.

Data readings are obtained from the EGRs of EGR powered system 104, utilizing electrical metering module 10332E, thermal metering module 10332T or photon metering module 10332P respectively being electrically, thermally or photon coupled. The energy meter data readings are transmitted over EGR network communication bus and stored in memory

EGR powered systems that generate power may be individually and uniquely associated with a blockchain wallet into which funds may be transferred. The EGR powered system can be provided with a client application that executes within the EGR powered system to determine an Energy Provider Billing Entity and the cost rate of energy supply. The client application calculates a value of energy generation by the EGR powered system and creates a blockchain transaction to transfer a funds value for the energy generation from the EGR powered system's blockchain wallet to a wallet of the Energy Provider Billing Entity. By providing EGR powered systems that can self-manage their electrical, thermal or photon energy supply and the accounting thereof, billing of power can be decentralized from a meter that meters individual EGR powered systems. The billing of power is automated through block chain energy smart contract, self-managed, no longer requires a physical billing address and bill to perform energy purchases.

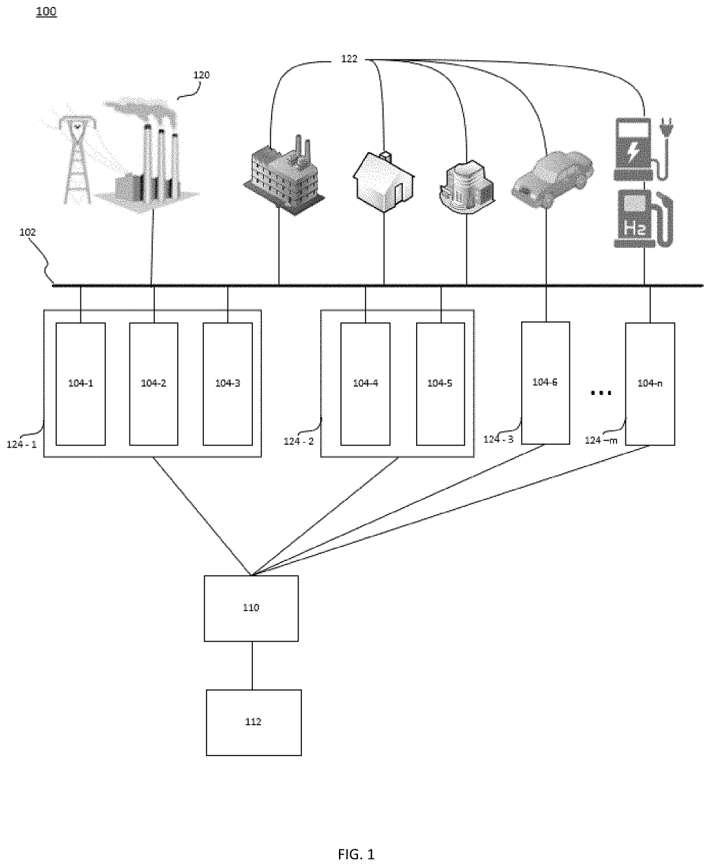

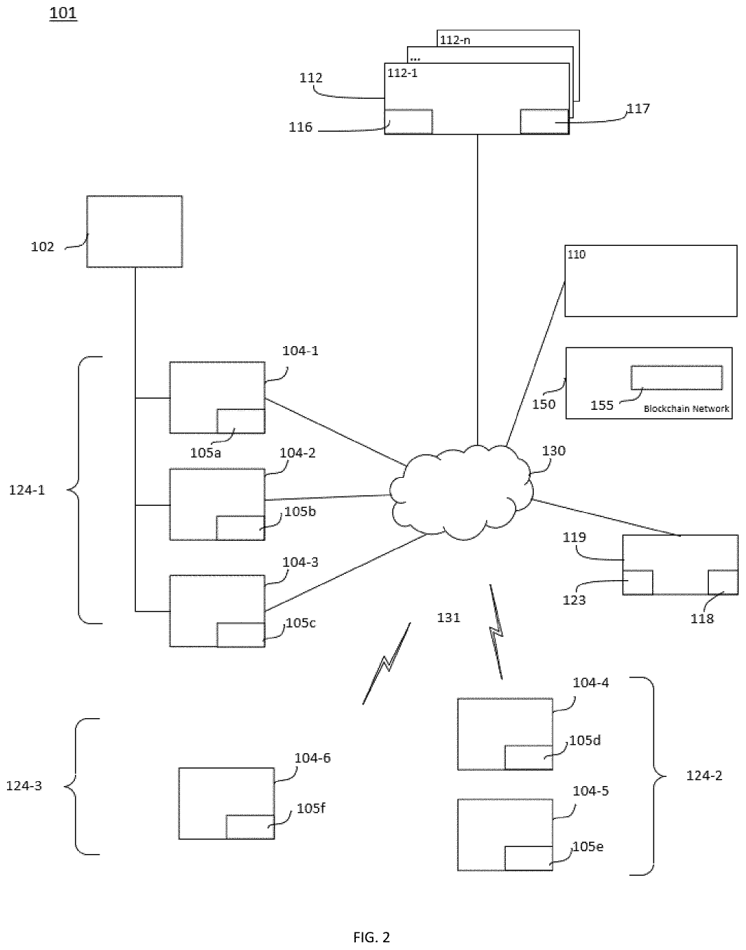

FIG. 2 illustrates a logic network diagram of a network 100 involving a blockchain network 150 for decentralizing electricity payments according to example embodiments. Referring to FIG. 2, the network 101 includes one or more Energy Provider Billing Entities 112 that may bill for energy supplied by an EGR powered system 104 to its owner/operator.

Energy distribution grid 102 may be connected to EGR powered systems 104 for the purpose of selling excess energy back to the Transmission System Operator 119. The Energy Provider Billing Entity 112 may also manage virtual power plants to consolidate EGR powered systems 104 across a region so they can participate in the trading of energy produced by EGR powered systems 104 to the electrical grid of a region. The Energy Provider Billing Entity 112 will provide a smart contract to enable owners of EGR powered systems 104 to receive a portion of the sales of electricity to be transacted by an Energy Provider Billing Entity 112 with the Transmission System Operator 119. Owner/operators of EGR powered systems 104 may be managed through virtual power plants controlled by the Energy Provider Billing Entity 112. Sales of energy produced by a distributed energy consumer using EGR powered systems 104 is offered as a credit transaction to the owner/operator of the EGR powered systems 104

The Transmission System Operator 119 has an associated blockchain wallet 118. The Transmission System Operator 119 may be configured to communicate with the blockchain 150 via a communications network 130 such as the Internet. The Transmission System Operator 119 may include or otherwise access a server 123. Via the server 123, the Transmission System Operator 119 is able to communicate with Energy Provider Billing Entity 112 using the communications network 130.

The Energy Provider Billing Entity 112 has an associated blockchain wallet 117. The Energy Provider Billing Entity 112 may be configured to communicate with the blockchain 150 via a communications network 130 such as the Internet. The Energy Provider Billing Entity 112 may include or otherwise access a server 116. Via the server 116, the Energy Provider Billing Entity 112 is able to provide various content to potential customers using the communications network 130. The content may include energy cost rates, environmental policies, supply location data, etc., and other such content to enable a customer to select the Energy Provider Billing Entity as their Billing provider. While only one Energy Provider Billing Entity 112 is shown, in a typical energy supply network, in other embodiments of the invention, there can be multiple Energy Provider Billing Entities capable of billing for energy costs to a particular EGR powered system or EGR powered systems. In one aspect of the invention, a distributed energy consumer will be able to choose their Energy Provider Billing Entity based on various factors including cost, reliability, renewable energy component, etc. A central information source may be created to provide information about all Energy Provider Billing Entities, their costs and location information.

The EGR powered systems 104, of which three EGR powered systems 104-1, 104-2 and 104-3 are shown as grouping 124-1 tethered to the electrical grid, may be located within a single premise or in multiple premises having a physical address location.

Exemplary EGR powered systems 104-4, 104-5 are shown as grouping 124-2 may be mobile EGR powered systems (such as a land, air, water vehicles) not tethered to the electrical grid Exemplary EGR powered systems 104-6 are shown as grouping 124-3 may be EGR powered systems not tethered to the electrical grid nor having any physical address location.

Such systems may communicate over wireless communications network 131.

The EGR powered systems may be owned by a single user or by multiple users. The EGR powered systems may be any of a number of energy generating EGR powered systems. EGR powered systems may include without limitation electrical, thermal, plasma, photon energy generating systems. Without limiting the uses, EGR power systems may include power generation equipment, H₂ refueling stations, electric refueling stations, air vehicles, land vehicles, water vehicles, space vehicles, residential, commercial, and industrial HVAC equipment, transportation systems, consumer appliances such as a telephone, fridge, television, computer, washing machine, toaster, oven, microwave oven, clock, home entertainment equipment, or any other EGR powered systems powered that deliver any of electricity, plasma, thermal, and/or photon energy. The EGR powered system may be a residential, commercial, industrial, military or space appliance. The EGR powered systems 104-1 thru 104-6, may include one or more power distribution components including adapters, electrical, thermal, photon, plasma energy meters for measuring/metering power generating EGR powered systems. Referring to FIG. 4, Electrical Power meters 10332E are shown for measuring/monitoring power in electrical power generating subsystem 4000; thermal power meter 10332T are shown for measuring/monitoring power in thermal power generating subsystem 5000; photon power meter 10332P are shown for measuring/monitoring power in photon power generating subsystem 6000.

The EGR powered system 104-1 thru 104-6 have hardware with compute powers, such as a processor and at least one operatively associated memory. The EGR powered system may be configured for internet communications via the network 130. Typically, though not exclusively, the EGR powered system may include a communications subsystem that is able to provide communications by wired or wireless WAN, wired or wireless LAN, cellular networks, satellite networks, Wi-Fi, Bluetooth. Alternatively, the EGR powered system may include one or more LAN connections that connect to a router. Alternatively, the EGR powered system may include a mobile communications module for accessing the internet via mobile telecommunications protocols. Alternatively, the EGR powered system may be configured to receive and send communication signals via the power lines. Other methods for providing internet communications to the EGR powered system will be apparent to the person skilled in the art.

The EGR powered system 104 may be configured with implementation software as will be described below. The EGR powered system may also be configured or associated with a respective EGR powered system wallet 105. In FIG. 2, each of the EGR powered systems 104-1, 104-2, 104-3, 104-4, 104-5, 104-6 has an associated EGR powered system wallet 105a, 105b, 105c, 105d, 105e, 105f respectively. The EGR powered system wallets 104-1, 104-2, 104-3, 104-4, 104-5, 104-6 provide the means for initiating transactions on the blockchain network, store account balances, transaction keys, transaction addresses (public/private keys, etc.).

Many EGR powered systems such as an automobile, a building may have a ready-made user interface and network connectivity. Such an interface may allow the EGR powered systems to be configured with the software and blockchain wallet after purchase and installation. EGR powered systems that do not have such an interface or application install capability may come from the factory with the software pre-installed. Similarly, EGR powered systems without user interface or application install capability would come from the factory with a blockchain wallet.

Each EGR powered system 104 is able to communicate with the blockchain network 150 via the network 130. The blockchain network 150 receives transactions from the EGR powered systems and/or the Energy Provider Billing Entity and may facilitate payments between the EGR powered systems and the Energy Provider Billing Entity as will be described in more detail below. The blockchain may utilize one or more smart contracts 155, including energy management contracts to undertake various blockchain processes.

FIG. 3 illustrates a logic diagram of a EGR powered system 104 according to example embodiments.

FIG. 3 illustrates an example of an EGR Powered System 104 connected to power grid 102 and a load 106. Power grid 102 is also shown in FIG. 1. In an embodiment of the invention the EGR Powered System 104 is delivering power to a load or delivering power to the Power grid 102. When delivering power to the load the Energy Provider Billing Entity charges the owner/operator of EGR Powered System 104 for power used. Conversely, when EGR Powered System 104 is generating power to the Power grid 102, the Energy Provider Billing Entity credits the owner/operator of EGR Powered System 104 for power sold to the energy markets. In general, a DVPP 110 can interoperate with any single one of EGR Powered Systems 104 or any of groups of EGR Powered Systems 104.

In general, DVPP 110 receives energy generation requests from Energy Provider Billing Entity 112 and, if that request can be satisfied by the resources represented by EGR Powered Systems, DVPP 110 instructs EGR Powered Systems in order to satisfy the power request.

An Energy Provider Billing Entity is an Entity that trades energy to the wholesale market on behalf of the EGR Powered systems owners/operators. Additionally, an Energy Provider Billing Entity is responsible for Billing owners/operators of EGR Powered systems for power they use for its particular application use

EGR Powered systems generally consist of the following subsystems as disclosed in Energy Generation Reactor Powered System application Ser. No. 17/855,526 Jun. 30, 2022.

Exemplary EGR powered systems may have all subsystems below or a subset of these systems depending on the end use or design of an EGR powered system and may include:
a) A Source of Atomic Hydrogen Fuel (such as water) 1
b) Water Splitting Apparatus Subsystem 2000
c) Atomic Hydrogen Generation Subsystem 3000
d) EGR Electrical Energy Generation Subsystem 4000
e) EGR Thermal Energy Generation Subsystem 5000
f) Thermal Energy Storage Subsystem 7000
g) EGR Photon Energy Generation Subsystem 6000
h) Thermal Energy Management Subsystem 8000
i) Electrical Energy Storage Subsystem 9000
j) Wireless Power/Wireless Communication Subsystem 10000
k) System Controller Subsystem 11000
l) IOT and Block Chain Subsystem 11500
m) Multiport Power Converter Subsystem 12000
n) Power Conditioning Subsystem 13000a (Load)
o) Power Conditioning Subsystem 13000b (Power Grid Interface)
p) A power, communication and control bus 14, 14a
q) Satellite Transceiver Module Communication Subsystem 11401 (optional)

Exemplary EGR subsystems are shown in FIG. 3 and FIG. 4

Referring to FIG. 4, an EGR powered system 104 will typically include a power connector 7a/8a for connection to an electrical load and/or to a mains grid power via connector 7b/8b. The power connector 7a/8a may be a standard 2 pin or 3 pin electrical plug, a USB connector, or any similar power connector that enables the EGR powered system 104 to connect to a power network (i.e., such as power distribution cabling in a building). The EGR powered system 104 may include power generating components. The EGR powered system may include Electrical Power Generating Components 4000 having an electrical power meter 10332E, Thermal Power Generating Components 5000 having a thermal power meter 10332T, or/and Photon Power Generating Components 6000 having a photon meter 10332P that that generate power to perform the intended functions of the EGR powered system. In some embodiments the Power Generating Components of the EGR Powered system may be one or more power generating components such 4000-1, 4000-2, 4000-3, thru 4000-n where n is the n^{th} electrical power generator; 5000-1, 5000-2, 5000-3, thru 5000-n where n is the n^{th} thermal power generator; power generating components such 6000-1, 6000-2, 6000-3, thru 6000-n where n is the n^{th} photon power generator. The present embodiments are not limited to one type of EGR powered system and thus the specific power generating components are not considered essential herein. In an alternative embodiment, the EGR powered system 104 may be any type of EGR powered system. The EGR powered system 104 may include a power meter, such as 10332E, 10332T, or 10332P for measuring the amount of power generation and energy delivered over time by the EGR powered system 104. The meters are not limited to measure EGR powered system power of types electrical, thermal, or photon energy. Such systems may be designed to measure and meter many tertiary forms of power.

The EGR powered system 104 further includes computing hardware such as a system controller subsystem 11000 and operatively associated memory 125. The memory may store software 126, instructions sets and code executable by the processor for performing a number of functions. The functions may include functions for operation of the EGR powered system, control programs, etc. The memory 125 may also store code for executing electricity management programs in accordance with example embodiments as will be described in more detail below, including communication with the blockchain network via Wireless Power/Wireless Communication Subsystem 10000. As described above, the wireless power/wireless communications subsystem module 10000 may include a transceiver 129 configured for communications via one or more of WiFi, WAN, LAN, WLAN, WWAN, mobile, or satellite telecommunications, etc.

The EGR powered system 104 contains a IoT and blockchain subsystem 11500.

The EGR powered system blockchain subsystem 11500 includes EGR powered system wallet 105. The wallet may be a hardware wallet or similar. The wallet 105 may store one or more keys that can be used to generate blockchain transactions on the blockchain network. In one embodiment, the EGR powered system wallet 105 may store a root key or master seed that is used to generate transaction addresses for blockchain transactions. The EGR powered system wallet 105 may utilize the processor and memory 127/128 or may be provided with its own dedicated processor, i.e., IC chip, and memory. EGR Powered systems utilize a power, communication and control bus 14, 14a to enable wired internal and external communication.

In one preferred embodiment EGR powered system wallet 105, processor/memory 127/128 is an Integrated Circuit MY8603, a System on a Chip (SOC) for BlockChain, Digital currency and IoT application available from MyTek Corp., 6F, No. 659, Bannan Rd. Zhonghe Dist., New Taipei City 23557, Taiwan (R.O.C.). The EGR powered system wallet 105, processor/memory 127/128 such as the MY8603 includes hardware crypto accelerator, USB 2.0 high-speed device controller, SD card reader controller, and popular serial interface controller having high performance and rich interfaces. MY8603 that can be easily applied to system manufacturing for BlockChain & IoT application of the current invention.

For Blockchain and Digital Currency use, the EGR powered system wallet 105, processor/memory 127/128 such as MY8603 implements a hardware accelerate crypto engine with Elliptic Curve Cryptography (ECC) standard supporting SECP256K1, SECP256R1, Curve25519 and Ed25519. Besides special ECC standard, the EGR powered system wallet 105, processor/memory 127/128 such as MY8603 also support other crypto standards including BASE(16/32/58/64/2048 bit), AES(128 bit/256 bit) and SHA(256 bit/512 bit/HMAC). For instance AES(128 bit/256 bit) is used for encryption at rest providing real time encryption and decryption of data, preventing any stored database from being stolen and read by a nefarious hacker or intruder. On the other hand, SHA (Secure Hash Algorithm), used for hashing records and certificates files. Every piece of record produces a unique hash that is very well non-duplicable through some other piece of record.

In addition to the hardware function, the chip provides complete firmware & software (including mobile app) for a variety of different block applications, enabling designers incorporating EGR Powered systems to quickly develop their own applications and get products to market. The firmware & software for Digital Currency may fit embodiments such as the Bitcoin (Bitcoin algorithm, BIP32, BIP44), Ethereum & ERC20 Tokens (support Smart Contact), Litecoin, Ripple, Bitcoin Cash & etc. For BlockChain IoT application, the worldwide standard liking IBM Hyperledger, R3 Corda and Quorum are available.

In the BlockChain and Digital Currency world, security is also a very important factor. The EGR powered system wallet 105, processor/memory 127/128 such as MY8603 provides a SOC embedded memory, for a highest security level. Private keys are stored in an extra secure storage chip (Wallet), to ensure that all information is not stolen.

In another preferred embodiment a Blockchain IOT System on a Chip called Skynet Core Chip and the Skynet Open Network may be substituted for the MY8603 SoC. A description of the IC is incorporated by reference in Skynet Whitepaper Creating the Intelligent Machine Economy Skynet Core—The First Blockchain System on Chip Skynet Open Network—A Novel Infinity Blockchain Network. Alexander Shi University of California, Berkeley CEO, Open Singularity Dr. Jae Jung Ph.D. University of California, San Diego CTO, Open Singularity Foundation Jul. 8, 2018 Version 1.0 Each EGR powered system blockchain subsystem 11500 may include a hash code ID 121 that can be used to identify the EGR powered system to one or more networks, including the blockchain network 150 shown in FIG. 2. The hash code ID 121 may be used to generate transactions for the EGR powered system's blockchain wallet 105.

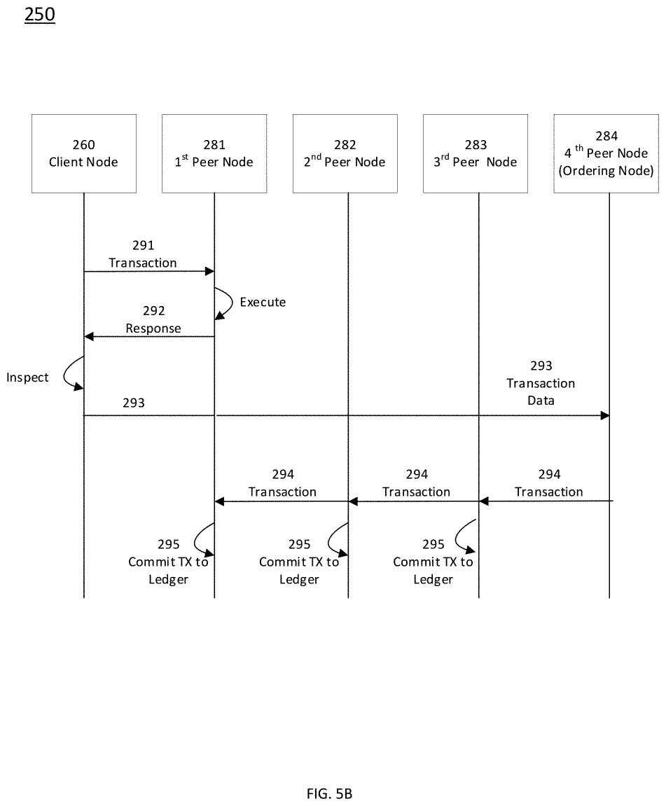

FIG. 5A illustrates a blockchain architecture configuration 200, according to example embodiments. Referring to FIG. 5A, the blockchain architecture 200 may include certain blockchain elements, for example, a group of blockchain nodes 202. The blockchain nodes 202 may include one or more nodes 204-210. (4 nodes are depicted by example only). These nodes participate in a number of activities, such as blockchain transaction addition and validation process (consensus). One or more of the blockchain nodes 204-210 may endorse transactions and may provide an ordering service for all blockchain nodes in the architecture 200. A blockchain node may initiate a blockchain authentication and seek to write to a blockchain immutable ledger stored in blockchain layer 216, a copy of which may also be stored on the underpinning physical infrastructure 214. The blockchain configuration may include one or applications 224 which are linked to application programming interfaces (APIs) 222 to access and execute stored program/application code 220 (i.e., chaincode, smart contracts, etc.) which can be created according to a customized configuration sought by participants and can maintain their own state, control their own assets, and receive external information. This can be deployed as a transaction and installed, via appending to the distributed ledger, on all blockchain nodes 204-210.

The blockchain base or platform 212 may include various layers of blockchain data, services (i.e., cryptographic trust services, virtual execution environment, etc.), and underpinning physical computer infrastructure that may be used to receive and store new transactions and provide access to auditors which are seeking to access data entries. The blockchain layer 216 may expose an interface that provides access to the virtual execution environment necessary to process the program code and engage the physical infrastructure 214. Cryptographic trust services 218 may be used to verify transactions such as asset exchange transactions and keep information private.

The blockchain architecture configuration of FIG. 5A may process and execute program/application code 220 via one or more interfaces exposed, and services provided, by blockchain platform 212. The code 220 may control blockchain assets. For example, the code 220 can store and transfer data, and may be executed by nodes 204-210 in the form of a smart contract and associated chaincode with conditions or other code elements subject to its execution. As a non-limiting example, smart contracts may be created to execute reminders, updates, and/or other notifications subject to the changes, updates, etc. The smart contracts can themselves be used to identify rules associated with authorization and access requirements and usage of the ledger. For example, EGR powered system power generation information may be processed by one or more processing entities (i.e., virtual machines) included in the blockchain layer 216. The energy transaction result 228 may include a transaction that transfers a value for power generated by the EGR powered system to the Energy Provider Billing Entity. The physical infrastructure 214 may be utilized to retrieve any of the data or information described herein.

Within chaincode, a smart contract may be created via a high-level application and programming language, and then written to a block in the blockchain. The smart contract may include executable code which is registered, stored, and/or replicated with a blockchain (i.e., distributed network of blockchain peers). A transaction is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation of a smart contract, with additional features. As described herein, the chaincode may be program code deployed on a computing network, where it is executed and validated by chain validators together during a consensus process. The chaincode receives a hash and retrieves from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details. In FIG. 5A, a smart contract 226 detailing an energy transaction may be provided to one or more of the nodes 204-210. The smart contract 226 may specify a EGR powered system wallet, an Energy Provider Billing Entity wallet, energy generation and a value of the energy generation, being the funds amount to be transferred from the EGR powered system wallet to the Energy Provider Billing Entity wallet.

FIG. 5B illustrates an example of a transactional flow 250 between nodes of the blockchain in accordance with an example embodiment. Referring to FIG. 5B, the transaction flow may include a transaction proposal 291 sent by an application client node 260 to an endorsing peer node 281. The endorsing peer 281 may verify the client signature and execute a chaincode function to initiate the transaction. The output may include the chaincode results, a set of key/value versions that were read in the chaincode (read set), and the set of keys/values that were written in chaincode (write set). The proposal response 292 is sent back to the client 260 along with an endorsement signature, if approved. The client 260 assembles the endorsements into a transaction payload 293 and broadcasts it to an ordering service node 284. The ordering service node 284 then delivers ordered transactions as blocks to all peers 281-283 on a channel. Before committal to the blockchain, each peer 281-283 may validate the transaction. For example, the peers may check the endorsement policy to ensure that the correct allotment of the specified peers have signed the results and authenticated the signatures against the transaction payload 293.

Referring again to FIG. 5B, the client node 260 initiates the transaction 291 by constructing and sending a request to the peer node 281, which is an endorser. The client 260 may include an application leveraging a supported software development kit (SDK), such as NODE, JAVA, PYTHON, and the like, which utilizes an available API to generate a transaction proposal. The proposal is a request to invoke a chaincode function so that data can be read and/or written to the ledger (i.e., write new key value pairs for the assets). The SDK may serve as a shim to package the transaction proposal into a properly architected format (i.e., protocol buffer over a remote procedure call (RPC)) and take the client's cryptographic credentials to produce a unique signature for the transaction proposal.

In response, the endorsing peer node 281 may verify (a) that the transaction proposal is well formed, (b) the transaction has not been submitted already in the past (replay-attack protection), (c) the signature is valid, and (d) that the submitter (client 260, in the example) is properly authorized to perform the proposed operation on that channel. The endorsing peer node 281 may take the transaction proposal inputs as arguments to the invoked chaincode function. The chaincode is then executed against a current state database to produce transaction results including a response value, read set, and write set. However, no updates are made to the ledger at this point. In 292, the set of values, along with the endorsing peer node's 281 signature is passed back as a proposal response 292 to the SDK of the client 260 which parses the payload for the application to generate.

In response, the application of the client 260 inspects/verifies the endorsing peer's signatures and compares the proposal responses to determine if the proposal response is the same. If the chaincode only queried the ledger, the application would inspect the query response and would typically not submit the transaction to the ordering node service 284. If the client application intends to submit the transaction to the ordering node service 284 to update the ledger, the application determines if the specified endorsement policy has been fulfilled before submitting (i.e., did all peer nodes necessary for the transaction endorse the transaction). Here, the client may include only one of multiple parties to the transaction. In this case, each client may have their own endorsing node, and each endorsing node will need to endorse the transaction. The architecture is such that even if an application selects not to inspect responses or otherwise forwards an unendorsed transaction, the endorsement policy will still be enforced by peers and upheld at the commit validation phase.

After successful inspection, in step 293 the client 260 assembles endorsements into a transaction and broadcasts the transaction proposal and response within a transaction message to the ordering node 284. The transaction may contain the read/write sets, the endorsing peers' signatures and a channel ID. The ordering node 284 does not need to inspect the entire content of a transaction in order to perform its operation, instead the ordering node 284 may simply receive transactions from all channels in the network, order them chronologically by channel, and create blocks of transactions per channel.

The blocks of the transaction are delivered from the ordering node 284 to all peer nodes 281-283 on the channel. The transactions 294 within the block are validated to ensure any endorsement policy is fulfilled and to ensure that there have been no changes to ledger state for read set variables since the read set was generated by the transaction execution. Transactions in the block are tagged as being valid or invalid. Furthermore, in step 295 each peer node 281-283 appends the block to the channel's chain, and for each valid transaction the write sets are committed to current state database. An event is emitted, to notify the client application that the transaction (invocation) has been immutably appended to the chain, as well as to notify whether the transaction was validated or invalidated.

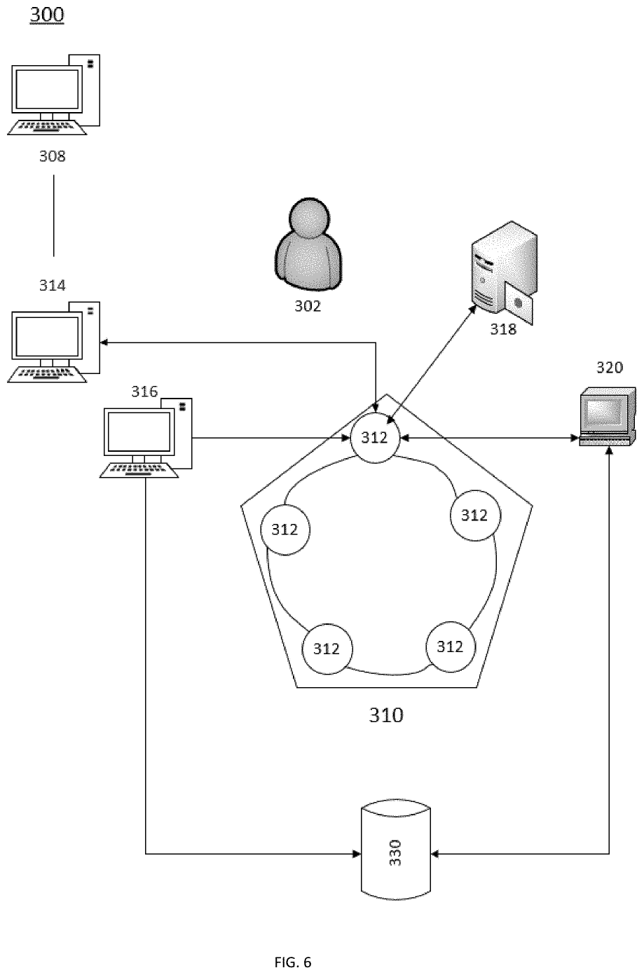

FIG. 6 illustrates an example of a permissioned blockchain network 300, which features a distributed, decentralized peer-to-peer architecture, and a certificate authority 318 managing user roles and permissions. In this example, the blockchain user 302 may submit a transaction to the permissioned blockchain network 310. In this example, the transaction can be a deploy, invoke or query, and may be issued through a client-side application leveraging an SDK, directly through a REST API, or the like. Trusted business networks may provide access to regulator systems 314, such as auditors (the Federal Energy Regulatory Commission in a U.S. energy market, for example). Meanwhile, a blockchain network operator system of nodes 308 manage member permissions, such as enrolling the regulator system 310 as an “auditor” and the blockchain user 302 as a “client.” An auditor could be restricted only to querying the ledger whereas a client could be authorized to deploy, invoke, and query certain types of chaincode.

A blockchain developer system 316 writes chaincode and client-side applications. The blockchain developer system 316 can deploy chaincode directly to the network through a REST interface. To include credentials from a traditional data source 330 in chaincode, the developer system 316 could use an out-of-band connection to access the data. In this example, the blockchain user 302 connects to the network through a peer node 312. Before proceeding with any transactions, the peer node 312 retrieves the user's enrollment and transaction certificates from the certificate authority 318. In some cases, blockchain users must possess these digital certificates in order to transact on the permissioned blockchain network 310. Meanwhile, a user attempting to drive chaincode may be required to verify their credentials on the traditional data source 330. To confirm the user's authorization, chaincode can use an out-of-band connection to this data through a traditional processing platform 320.

Blockchain networks of the type described above may be used to process payments for many users. Typically, payments are made between users and companies by transferring value from a user wallet to a company wallet. In the present embodiments, the blockchain wallet is created at the EGR powered system level to enable individual EGR powered systems to self-manage the accounting and payment for the EGR powered system's energy generation. A client application that executes within the EGR powered system provides the logic for calculating the cost for the energy consumed and the budget available.

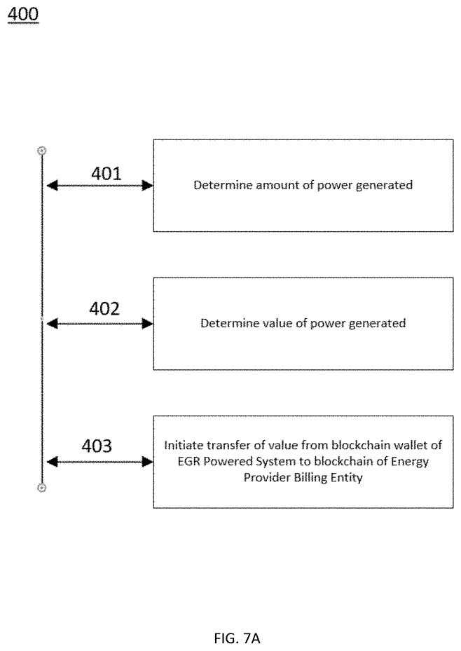

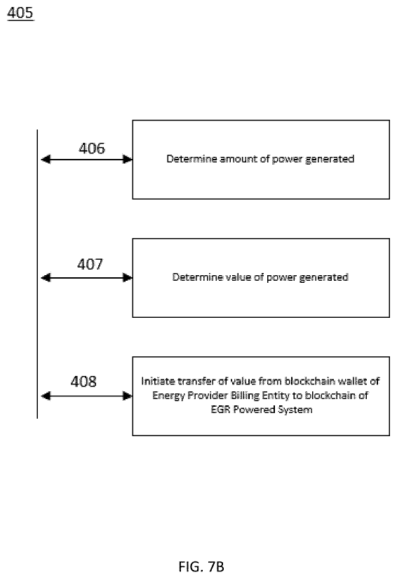

FIG. 7A In accordance with an embodiment of the present invention shows a flow chart steps 400, there is provided a system and method by which the charge for energy generation is decentralized from a centralized bill to individual EGR powered systems. At step 401, a EGR powered system determines the amount of power generation and energy delivered over time by the EGR powered system. The value for the power generated may be accumulated over a pay period such as over a month as determined by the smart contract terms. The power may be generated by the EGR powered system itself, or by one or more second EGR powered systems connected to the 1st EGR powered system. The power generation may be a forecast generation or a previous generation. At step 402, the EGR powered system calculates a value for the power generated. At step 403 the transfer of the value of power generated in step 402 is initiated from the wallet of EGR powered system to wallet of the Energy Provider Billing Entity.

FIG. 7B In accordance with an embodiment of the present invention shows a flow chart steps 405, there is provided a system and method by which the charge for energy generation is decentralized from a centralized bill to individual EGR powered systems. At step 406, a EGR powered system determines the amount of power generation and energy delivered over time by the EGR powered system. The value for the power generated may be accumulated over a pay period such as over a month as determined by the smart contract terms. The power may be generated by the EGR powered system itself, or by one or more second EGR powered systems connected to the 1st EGR powered system. The power generation may be a forecast generation or a previous generation. At step 407, the EGR powered system calculates a value for the power generated. At step 408 the transfer of the value of power generated in step 406 is initiated from the wallet of Energy Provider Billing Entity to wallet of the EGR powered system (i.e., a credit applied).

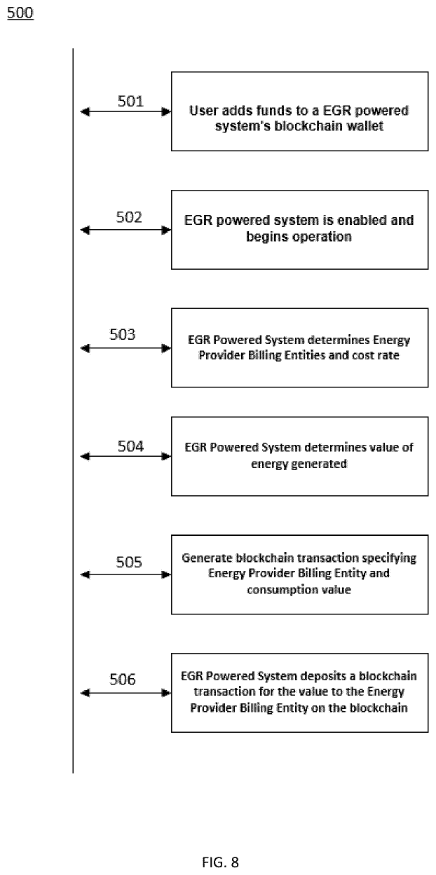

FIG. 8 shows a flowchart 500 for a specific method in accordance with example embodiments. At step 501, a user adds funds to a EGR powered system's blockchain wallet. At step 502, the EGR powered system is enabled and begins operation. The EGR powered system establishes an internet or communications network connection to a source of Energy Provider Billing Entity data and the EGR powered system selects an Energy Provider Billing Entity at an associated cost rate (step 503). Step 504 the EGR powered system calculates a value of energy generation and generates a blockchain transaction (i.e., smart contract) that specifies the generation value and the Energy Provider Billing Entity wallet as the recipient address. Step 505 the EGR powered system generates the blockchain transaction specifying Energy Provider Billing Entity and consumption value Step 506, the EGR powered system then deposits the smart contract on the blockchain, by submitting the smart contract to a network peer, endorsing node, etc. of the blockchain network. The calculated energy generation may be a forecast or anticipated generation or may be a past generation, either an actual measured generation or an estimate.

The EGR powered system may be programmed so that electrical power to any of the main power generation components, or any other connected power generating EGR powered systems, is prevented until there is sufficient funds in the blockchain wallet. The EGR powered system and/or supplier may allow small amounts of power to be consumed for free for managing the EGR powered system wallet.

The blockchain transaction may be conducted at various times and intervals, depending on factors including the nature of the EGR powered system, the requirements of the Energy Provider Billing Entity, the funds available in the EGR powered system wallet, user preferences, etc. For example, a permanently connected EGR powered system such as a residential EGR powered generator may account for its power generation over long intervals, i.e., daily, weekly, etc.

Some EGR powered systems that are used intermittently may have a shorter accounting period, i.e., hourly, daily, weekly, monthly whereas other EGR powered systems that are mobile such as EGR powered vehicles (i.e., EVs). As a rental vehicle, a blockchain contract for every time the vehicle is operated by a user during the contract period charges may be automatically billed to the Energy Provider Billing Entity for fueling charges either to the vehicle rental company or the end user. Another embodiment is related to vehicles in shared transportation contracts such as Lyft or Uber services are utilized by contracted drivers. In another embodiment of shared transportation industry, automobile manufacturers may provide a service where EGR powered vehicles refueling is tied to the automobile time of use contracts.

The method 500 of FIG. 8 may be implemented across many EGR powered systems and many Energy Provider Billing Entities. The method eliminates the need to have an account or a responsible party for the energy consumed on a certain location by decentralizing the payment for the energy generation from a centralized bill to individual EGR powered systems, thereby removing the need for a central meter on the premises and the reading thereof. Each EGR powered system manages energy generation individually and, importantly, each EGR powered system handles the financial process using blockchain via EGR powered system wallet 105 that is uniquely assigned to the EGR powered system. The use of blockchain technology ensures a secure billing process that needs a consensus to be approved. Consensus may be reached on location, contract, wallet ID amongst other aspects of the transaction.

The blockchain intelligence that enables the EGR powered system to be self-managing in terms of its power supply, generation and accounting, is provided by a client application that runs as software 126 on the computing hardware components 125, 127 of the EGR powered system 104 (see FIG. 4) and/or within the EGR powered system wallet 105. The client application is associated with the EGR powered system blockchain wallet which comes with a hash code to identify the wallet.

The client application is programmed to search for an Energy Provider Billing Entity and the energy cost rate for the provider for the EGR powered systems. The cost rate may be a fixed rate or a time-based rate, i.e. having a peak rate, off-peak rate, shoulder rate, etc. If the EGR powered system 104 has a screen or similar that can provide a user interface, then the user may be provided to enter or at least verification data and may be given an option to choose an energy plan from a list of providers. Alternatively, if the EGR powered system 104 does not provide a user interface, the EGR powered system may be programmed to conduct its own internet search and Energy Provider Billing Entity selection. The EGR powered system may access internet links via a communication link to a premises router. The link may be a Wi-Fi link, WWAN, WLAN, cellular, satellite or cable link. Alternatively, the EGR powered system may include a mobile Wireless Power/Wireless Communication Subsystem 10000 module. Alternatively, the EGR powered system may receive communication signals via the electrical supply lines.

Once the client application has determined an Energy Provider Billing Entity for the EGR powered system and the advertised cost rate for the selected Energy Provider Billing Entity, the client is able to generate a smart contract for the power supplied. The client application is able to the check the EGR powered system's blockchain wallet balance to determine the funds available and determine the EGR powered system's energy generation requirements. The client application then generates a blockchain transaction for a value of the energy generation based on the cost rate.

In one embodiment, the smart contract operates as a payment in advance for energy costs of the EGR powered system. The client application obtains a cost rate for an Energy Provider Billing Entity, forecasts an energy generation for the EGR powered system, and if the forecast value can be met by the funds in the EGR powered system's wallet, prepares a smart contract based on that value and deposits the contract on the blockchain.

The EGR powered system then monitors the energy generation of the EGR powered system using internal metering (i.e., via one or more of internal meters 10332E, 10332T, or 10332P) and real-time cost rates, including any time-varying rates, and operates until an amount of energy equivalent to the smart contract value has been consumed. The client application may include actual generation data as a transaction on the blockchain to provide integrity to the accounting system.

The payment in advance system has a benefit by informing the Energy Provider Billing Entity of the power requirements. The Energy Provider Billing Entity can therefore ensure that the supply demands of the EGR powered system can be met.

In an alternative embodiment, payment may be made in arrears. The client application may monitor power usage by the EGR powered system with the knowledge of the amount of funds in the EGR powered system's wallet and the real-time cost rate of the power from an Energy Provider Billing Entity, including any time-varying rate. Periodically, i.e., hourly, daily, etc., every time the EGR powered system is connected/disconnected, or if the wallet funds have been exhausted, the client application on the EGR powered system prepares a smart contract that provides an account of the power consumed, the real-time cost rate including cost fluctuations during the peak/off-peak cycle, and the value to be transferred from the EGR powered system wallet to the provider wallet. The client application deposits the transaction on the blockchain.

The EGR powered system software is responsible for checking if funds are available on the EGR powered system's wallet for the energy generation and to carry out the real-time cost calculation and withdraw from the EGR powered system's wallet. Once a connection is established with the internet, the EGR powered system's wallet will conclude the blockchain transaction by initiating the sending of the funds to the Energy Provider Billing Entity's blockchain wallet.

The client application may be programmed to periodically re-conduct the search of Energy Provider Billing Entities to ensure that the EGR powered system continues to receive the most favorable power supply cost rate.

Prior to the initial start-up, the user that purchases the self-managing EGR powered system, allocates funds to the EGR powered system's blockchain wallet. The user may allocate funds in a single transaction. In one embodiment, the user may be responsible for multiple EGR powered systems. The user may create a recurring transaction to periodically transfer funds into the blockchain wallets of each of the user's EGR powered systems to ensure that each EGR powered system is able to manage its power requirements and accounting for continuous operation with an uninterrupted power supply. If at any time the client application on the EGR powered system determines that there are insufficient funds to continue operation, the EGR powered system may revert to generating power only for wallet management functions. Other functions of the EGR powered system may shut down, stop charging, or revert to battery power if available. Notifications may be sent to the user responsible for the EGR powered system to enable the user to deposit more funds into the EGR powered system's wallet.

The EGR powered system itself is responsible for measuring the amount of power generated. Metering may be simple metering. For example, the EGR powered system may be configured with an energy rating that states the average generation per operational hour. The EGR powered system may use this simple rate of generation to calculate an overall generation. Alternatively, metering may include metering components to measure the actual energy consumed by the EGR powered system, in particular during fluctuating power loads on the EGR powered system for electrical, thermal or photon energy supply.

A user can add funds to the EGR powered system wallet using available blockchain wallet management. The user that adds the funds need not be the purchasing user. Any user with a vested interest in operating the EGR powered system may be allowed to add funds to the EGR powered system's wallet. This allows ownership of the EGR powered system to change without the need for changes in billing entity, billing address, etc. Smart contracts may be employed within the blockchain network to only certain authorized users to contribute funds to a EGR powered system's wallet. The use of a blockchain network or similar cryptographic distributed ledger as described herein for use in self-management of power accounting by power generating EGR powered systems may have several advantages. Funds may be verified prior to energy generation with the cost rate communicated at the time of energy generation. The blockchain network removes the need for a responsible party for energy generation account, removes the need for a billing address and provides secured, consensus-based payments. EGR powered systems can be sold or exchanged without the need to transfer account or responsible party because the blockchain wallet is associated directly to the EGR powered system.

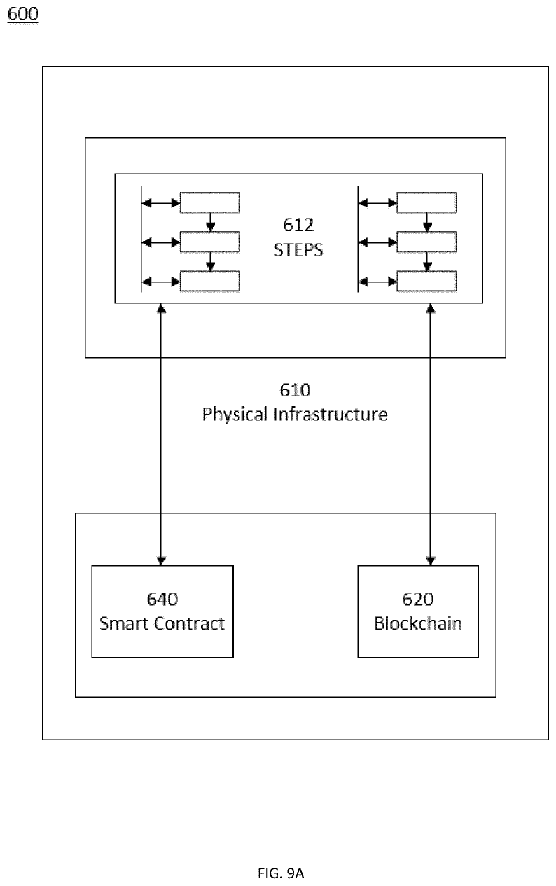

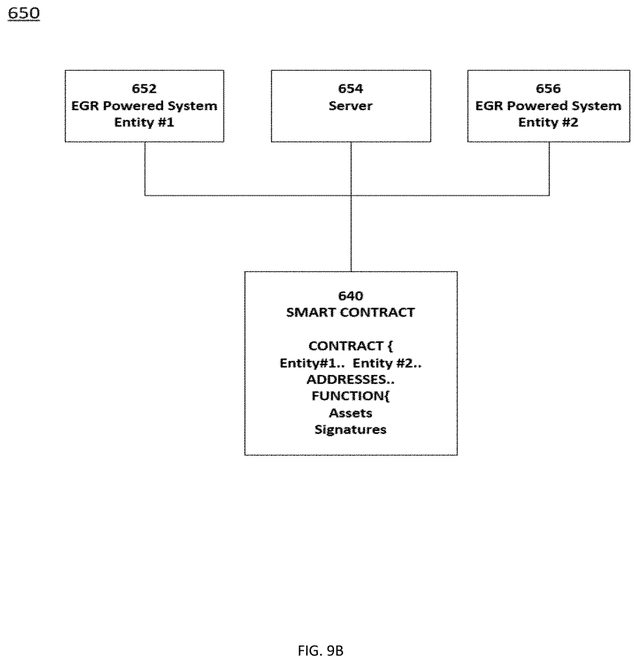

FIG. 9A illustrates an example physical infrastructure configured to perform various operations on the blockchain in accordance with one or more of the example methods of operation according to example embodiments. Referring to FIG. 9A, the example configuration 600 includes a physical infrastructure 610 with a blockchain 620 and a smart contract 640, which may execute any of the operational steps 612 included in any of the example embodiments. The steps/operations 612 may include one or more of the steps described or depicted in one or more flow diagrams and/or logic diagrams. The steps may represent output or written information that is written or read from one or more smart contracts 640 and/or blockchains 620 that reside on the physical infrastructure 610 of a computer system configuration. The data can be output from an executed smart contract 640 and/or blockchain 620. The physical infrastructure 610 may include one or more computers, servers, processors, memories, and/or wired/wireless communication EGR powered systems.

FIG. 9B illustrates an example smart contract configuration among contracting parties and an Energy Provider Billing Entity 654 configured to enforce the smart contract terms on the blockchain according to example embodiments. Referring to FIG. 9B, the configuration 650 may represent a communication session, an asset transfer session or a process or procedure that is driven by a smart contract 640 which explicitly identifies one or more user EGR powered systems 652 and/or 656. The execution, operations and results of the smart contract execution may be managed by a Energy Provider Billing Entity 654. Content of the smart contract 640 may require digital signatures by one or more of the entities 652 and 656 which are parties to the smart contract transaction. The results of the smart contract execution may be written to a blockchain as a blockchain transaction.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), Non-volatile RAM (“NRAM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components.

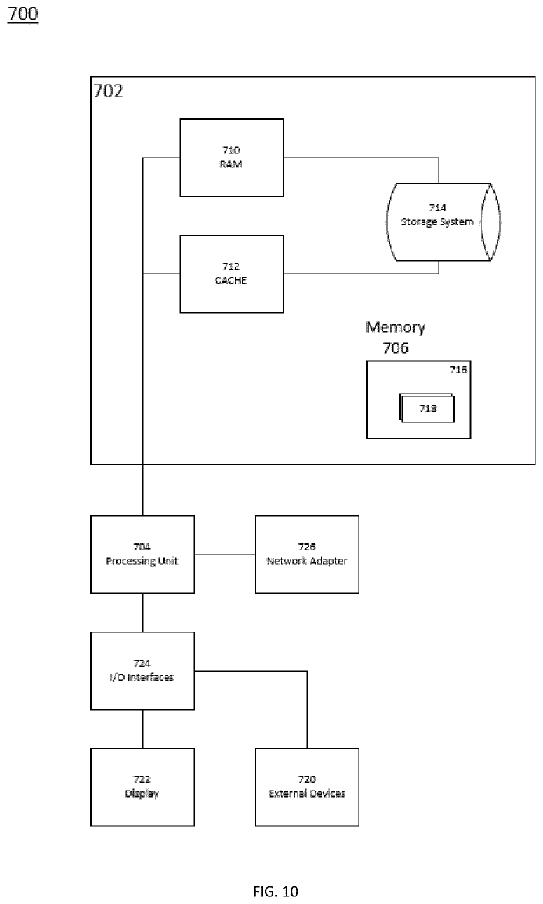

For example, FIG. 10 illustrates an example computer system architecture 700, which may represent or be integrated in any of the above-described components, etc.

FIG. 10 is not intended to suggest any limitation as to the scope of use or functionality of embodiments of the application described herein. Regardless, the computing node 700 is capable of being implemented and/or performing any of the functionality set forth hereinabove.

In computing node 700 there is a computer system/server 702, which is operational with numerous other general purposes or special purpose computing system environments or configurations. Examples of well-known computing systems, environments, and/or configurations that may be suitable for use with computer system/server 702 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 702 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 702 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 10, computer system/server 702 in computing node 700 is shown in the form of a general-purpose computing device. The components of computer system/server 702 may include, but are not limited to, one or more processors or processing units 704, a system memory 706, and a bus that couples various system components including system memory 706 to processor 704.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 702 typically includes a variety of computer system readable media. Such media may be any available media that is accessible by computer system/server 702, and it includes both volatile and non-volatile media, removable and non-removable media. System memory 706, in one embodiment, implements the flow diagrams of the other figures. The system memory 706 can include computer system readable media in the form of volatile memory, such as random-access memory (RAM) 710 and/or cache memory 712. Computer system/server 702 may further include other removable/non-removable, volatile/non-volatile computer system storage media. By way of example only, storage system 714 can be provided for reading from and writing to a non-removable, non-volatile magnetic media (not shown and typically called a “hard drive”). Although not shown, a magnetic disk drive for reading from and writing to a removable, non-volatile magnetic disk (i.e., a “floppy disk”), and an optical disk drive for reading from or writing to a removable, non-volatile optical disk such as a CD-ROM, DVD-ROM or other optical media can be provided. Storage system 714 can be may include, but are not limited to, one or more solid-state media for reading from and writing may be utilized such DRAM, Nonvolatile flash. In a preferred embodiment Nantero—NRAM which has essentially zero power consumption in standby mode and 160× lower write energy per bit than flash, and is highly resistant to environmental forces (heat even up to 300 degrees C., cold, magnetism, radiation, vibration) is the preferred storage media.

In such instances, each can be connected to the bus by one or more data media interfaces. As will be further depicted and described below, system memory 706 may include at least one program product having a set (i.e., at least one) of program modules that are configured to carry out the functions of various embodiments of the application.

Program/utility 716, having a set (at least one) of program modules 718, may be stored in system memory 706 by way of example, and not limitation, as well as an operating system, one or more application programs, other program modules, and program data. Each of the operating system, one or more application programs, other program modules, and program data or some combination thereof, may include an implementation of a networking environment. Program modules 718 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon. Computer system/server 702 may also communicate with one or more external devices 720 such as a keyboard, a pointing device, a display 722, etc.; one or more devices that enable a user to interact with computer system/server 702; and/or any devices (i.e., network card, modem, etc.) that enable computer system/server 702 to communicate with one or more other computing devices. Such communication can occur via I/O interfaces 724. Still yet, computer system/server 702 can communicate with one or more networks such as a local area network (LAN), a general wide area network (WAN), a general wireless wide area network (WWAN), and/or a public network (i.e., the Internet) via network adapter 726. As depicted, network adapter 726 communicates with the other components of computer system/server 702 via a bus. It should be understood that although not shown, other hardware and/or software components could be used in conjunction with computer system/server 702. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, solid state memory, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (i.e., protocols, hardware devices, software platforms etc.) thereto.

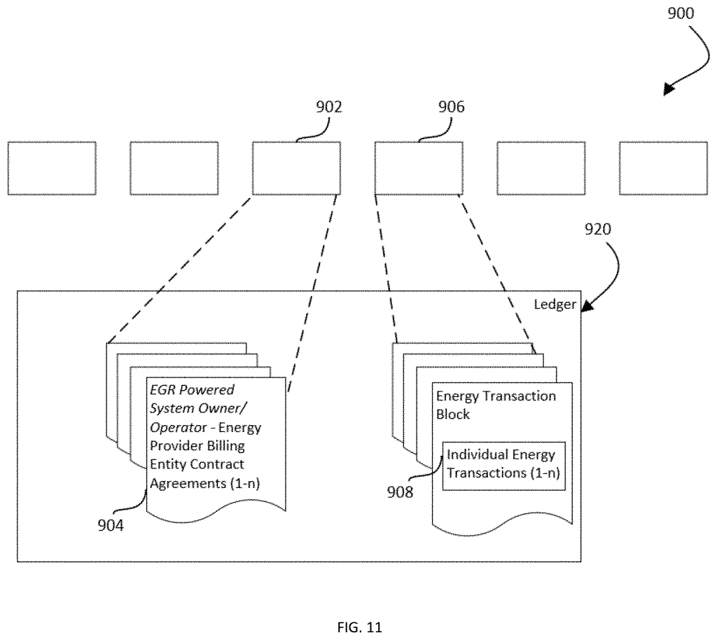

FIG. 11 illustrates a block chain 900 that may be maintained by the nodes in the distributed peer-to-peer network 202. Blocks of the blockchain 900 may include one or more blocks 902 which may contain one or more EGR Powered System Owner/Operator—Energy Provider Billing Entity contract agreements 904 and one or more blocks 906 which may contain one or more individual energy transactions 908.

The EGR Powered System Owner/Operator—Energy Provider Billing Entity contract agreements 904 may contain the terms and conditions under which an Energy Provider Billing Entity may agree to charge for a quantity of energy, for example a certain number of kilowatts, megawatts or gigawatts of electricity, to an EGR Powered System Owner/Operator during a contract interval. The individual energy transactions are each a physical energy quantity mentioned in the contract agreement to be charged by the Energy Provider Billing Entity to the EGR Powered System Owner/Operator as per the contract agreement and to be settled through a settlement routine. The contract agreement contains pertains to the actual usage of energy by the EGR Powered System Owner/Operator

The usage is “Settled through a settlement routine” means that the Energy Provider Billing Entity will charge for a quantity of energy consumed by the EGR Powered System Owner/Operator whereby the EGR Powered System Owner/Operator has acknowledged the quantity of energy consumed at the end of a period and has authorized payment to the Energy Provider Billing Entity.

Such purchases of energy by the EGR Powered System Owner/Operator may occur during an agreed upon interval. The interval can be at the end of each day and the purchase and payment for the energy may be settled at the end of the business day. Alternatively, the consumed energy purchase interval by the EGR Powered System Owner/Operator can be some other interval (i.e. weekly, biweekly, monthly).

“Settled through a settlement routine” means that the EGR powered systems have consumed a quantity of energy, the Energy Provider Billing Entity has acknowledged receipt of the quantity of consumed energy and an authorized payment from the EGR powered system owner/operator's wallet for energy consumed during the contract will be transferred to the Energy Provider Billing Entity wallet. The individual energy transactions are each a physical energy quantity mentioned in the contract agreement of energy used by the EGR Powered System Owner/Operator as per the contract agreement and to be settled through a settlement routine. The contract agreement contained the energy used by the EGR Powered System Owner/Operator and the actual energy consumed over the contract interval and as documented as individual energy transactions 908.

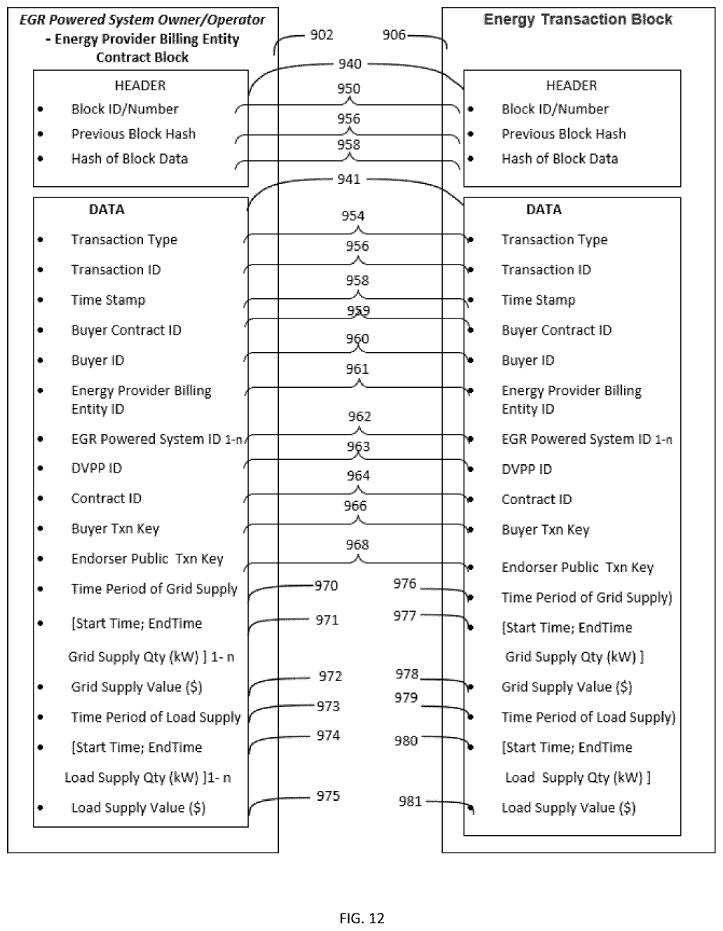

Referring now to FIG. 12, the EGR Powered System Owner/Operator—Energy Provider Billing Entity contract block 902 and the Energy transaction block 906. These 2 types of blocks have common details but also some differences.

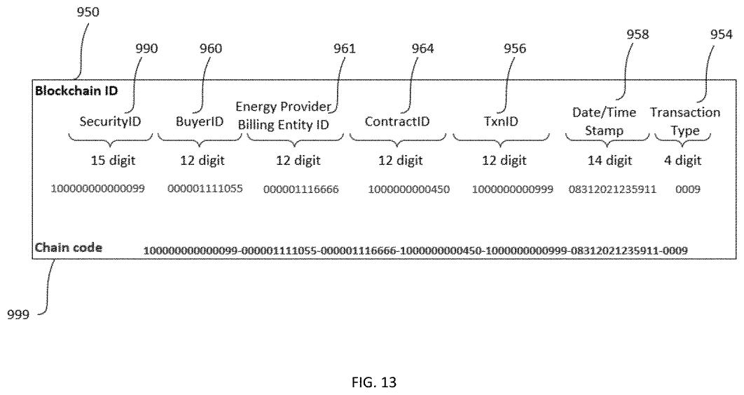

First, the common details of the types of blocks will be described. Each of the blocks has a Blockchain ID 950 in the header which is a block unique identifier in each block chain. Blockchain ID 950 is described in more detail with respect to FIG. 13. The Blockchain ID 950 actually contains digits representing data that is contained in the body of the EGR Powered System Owner/Operator—Energy Provider Billing Entity contract block 902 and the Energy transaction block 906.

Thus, Blockchain ID 950 contains digits representing a security identifier 990, a buyer identifier 960, an Energy Provider Billing Entity identifier 961, a contract identifier 964, a Transaction Identifier 956, a date/time stamp 958 and a Transaction Type 954. When all of the components of the Blockchain ID 950 are put together, the Blockchain ID 950 appears as a chain code 999. The digits shown in FIG. 13 are for the purpose of illustration and not limitation.

Returning back to FIG. 12, the EGR Powered System Owner/Operator—Energy Provider Billing Entity contract block 902 and the Energy transaction block 906 having Header 940 contain a previous block hash 952 which is a hash value of the previous block for historical traceability of block and a Hash of Block Data 953 which is a hash value of the block data.

The buyer-Energy Provider Billing Entity contract block 902 and the Energy transaction block 906 having Data 941 related to the both the contract and energy data.

The Transaction Type 954 is the type of transaction the block represents, for example, the EGR Powered System Owner/Operator—Energy Provider Billing Entity contract, the individual energy transaction, or group energy transaction. The Transaction ID 956 is the Transaction Identifier within the Transaction Type 954.

The date/time stamp 958 is a date/time stamp when the block is committed to the block chain.

The Buyer ID 960 is a unique Identifier for the buyer. The Energy Provider Billing Entity ID 961 is a unique Identifier for the Energy Provider Billing Entity while the EGR powered system ID 962 is a unique identifier for the EGR powered system.

The DVPP ID 963 is an identifier of the DVPP that aggregates the set of EGR Powered Systems to fulfil the energy generation request received from the Energy Provider Billing Entity.

The Contract ID 964 is a contract identifier as referred to in the EGR Powered System Owner/Operator—Energy Provider Billing Entity contract agreement between EGR Powered System Owner/Operator and Energy Provider Billing Entity and may be obtained from the Energy Provider Billing Entity's Contract management system (CMS). The Endorser's Public TXN key 968 is an endorser's public security key which encrypts the EGR Powered System Owner/Operator—Energy Provider Billing Entity contract agreement block 902 and energy transaction block 906.

The following details may appear only in the EGR Powered System Owner/Operator—Energy Provider Billing Entity contract block 902 and the energy transaction block 906.

The Energy Provider Billing Entity ID 961 is a unique Identifier for the Energy Provider Billing Entity. The Time period of Grid Supply 970 in the EGR Powered System Owner/Operator—Energy Provider Billing Entity contract block 902 is the Time period of Supply for bulk energy as referred to in the EGR Powered System Owner/Operator—Energy Provider Billing Entity contract between EGR Powered System Owner/Operator and Energy Provider Billing Entity in the CMS. Also included only in the EGR Powered System Owner/Operator—Energy Provider Billing Entity contract block 902 is the [Start Supply time, End Supply time, Grid Supply Quantity (kW)] 971 which sets forth the details for the set of energy transactions as planned in the EGR Powered System Owner/Operator—Energy Provider Billing Entity contract between EGR Powered System Owner/Operator and Energy Provider Billing Entity CMS. Within the contracted energy purchase interval by the EGR Powered System Owner/Operator the Energy Provider Billing Entity in reality receives calculated amount of energy generated during the contract interval. So, each quantity of energy for the contract time period is denoted as [Start Supply time, End Supply time, Supply Quantity (kW)]. The price per kW is not required to be included in the EGR Powered System Owner/Operator—Energy Provider Billing Entity contract block 902. However, if desired, the price per kW may be included in the EGR Powered System Owner/Operator—Energy Provider Billing Entity contract block 902. The grid supply value 972 of energy provided back as credit for generation of energy to the power grid.

The Energy Provider Billing Entity ID 961 is a unique Identifier for the Energy Provider Billing Entity. The Time period of Load Supply 973 in the EGR Powered System Owner/Operator—Energy Provider Billing Entity contract block 902 is the Time period of Supply for bulk energy as referred to in the EGR Powered System Owner/Operator—Energy Provider Billing Entity contract between EGR Powered System Owner/Operator and Energy Provider Billing Entity in the CMS. Also included only in the EGR Powered System Owner/Operator—Energy Provider Billing Entity contract block 902 is the [Start Supply time, End Supply time, Load Supply Quantity (kW)] 974 which sets forth the details for the set of energy transactions as planned in the EGR Powered System Owner/Operator—Energy Provider Billing Entity contract between EGR Powered System Owner/Operator and Energy Provider Billing Entity CMS. Within the contracted energy purchase interval by the EGR Powered System Owner/Operator the Energy Provider Billing Entity in reality receives calculated amount of energy generated during the contract interval. So, each quantity of energy for the contract time period is denoted as [Start Supply time, End Supply time, Supply Quantity (kW)]. The price per kW is not required to be included in the EGR Powered System Owner/Operator—Energy Provider Billing Entity contract block 902. However, if desired, the price per kW may be included in the EGR Powered System Owner/Operator—Energy Provider Billing Entity contract block 902. The Load supply value 975 of energy provided back as credit for generation of energy to the power grid.

The Time period of Grid Supply 976 in the Energy transaction block 906 is the Time period of Grid Supply to 976 for bulk energy as referred to in the EGR Powered System Owner/Operator—Energy Provider Billing Entity contract between EGR Powered System Owner/Operator and Energy Provider Billing Entity in the CMS. Also included only in the Energy Transaction block 902 is the [Start Supply time, End Supply time, Grid Supply Quantity (kW)] 977 which sets forth the details for the set of energy transactions as planned in the EGR Powered System Owner/Operator—Energy Provider Billing Entity contract between EGR Powered System Owner/Operator and Energy Provider Billing Entity CMS. Within the contracted energy purchase interval by the EGR Powered System Owner/Operator the Energy Provider Billing Entity in reality receives calculated amount of energy consumed during the contract interval. So, each quantity of energy for the contract time period is denoted as [Start Supply time, End Supply time, Supply Quantity (kW)] 980. The price per kW is not required to be included in the EGR Powered System Owner/Operator—Energy Provider Billing Entity contract block 902. However, if desired, the price per kW may be included in the EGR Powered System Owner/Operator—Energy Provider Billing Entity contract block 902. The grid supply value 978 of energy provided back as credit for generation of energy to the power grid.

The Time period of Load Supply 979 in the EGR Powered System Owner/Operator—Energy Provider Billing Entity contract block 902 is the Time period of Load Supply to 979 for bulk energy as referred to in the EGR Powered System Owner/Operator—Energy Provider Billing Entity contract between EGR Powered System Owner/Operator and Energy Provider Billing Entity in the CMS. Also included only in the Energy Transaction block 906 is the [Start Supply time, End Supply time, Load Supply Quantity (kW)] 980 which sets forth the details for the set of energy transactions as planned in the EGR Powered System Owner/Operator—Energy Provider Billing Entity contract between EGR Powered System Owner/Operator and Energy Provider Billing Entity CMS. Within the contracted energy purchase interval by the EGR Powered System Owner/Operator the Energy Provider Billing Entity in reality receives calculated amount of energy consumed during the contract interval. So, each quantity of energy for the contract time period is denoted as [Start Supply time, End Supply time, Load Supply Quantity (kW)] 980. The price per kW is not required to be included in the Energy transaction block 906. However, if desired, the price per kW may be included in the Energy transaction block 906. The load supply value 981 of energy provided back as charge for generation of energy to the load.

What is claimed is:

1. A method, comprising: determining, by a EGR powered system the amount of power generation and energy delivered over time by the EGR powered system; determining, by the EGR powered system, a value for the power generation; and initiating, by the EGR powered system, a transfer of the value from a EGR powered system blockchain wallet associated with the EGR powered system to a provider blockchain wallet associated with an Energy Provider Billing Entity for the power generation.

2. The method of claim 1 comprising determining, by the EGR powered system, an Energy Provider Billing Entity for the EGR powered system, and a cost rate of the energy charged by the Energy Provider Billing Entity.

3. The method of claim 2 comprising selecting, by the EGR powered system, a lowest cost Energy Provider Billing Entity for the period of the power generation.

4. The method of claim 1 wherein the EGR powered system blockchain wallet is uniquely associated to the EGR powered system.

5. The method of claim 1 comprising receiving a value into the EGR powered system blockchain wallet from a user blockchain wallet of a purchaser of the EGR powered system.

6. The method of claim 1 comprising generating, by the EGR powered system, a smart contract for the blockchain, wherein the smart contract indicates the EGR powered system blockchain wallet, the provider blockchain wallet, and the value.

7. The method of claim 1 comprising measuring the power generation of one or more power generating components of the EGR powered system.

8. The method of claim 1 comprising measuring the power generation generated by the EGR powered system.

9. A EGR powered system, comprising: EGR powered system having one or more power meters that measure power generation produced by the EGR powered system; one or more processors and one or more memories operatively associated with the processor; one or more instructions sets executable by the one or more processors that, when executed, cause the one or more processors to perform: a calculation of a cost of power generation for the EGR powered system; an initiation of a transfer of a value for the cost of power generation for the EGR powered system from a EGR powered system blockchain wallet associated with the EGR powered system to a provider blockchain wallet associated with an Energy Provider Billing Entity for the power generation.

10. The EGR powered system of claim 9 wherein the one or more processors is programmed to select an Energy Provider Billing Entity for the EGR powered system, and a cost rate of the energy charged by the Energy Provider Billing Entity.

11. The EGR powered system of claim 10 wherein the one or more processors is programmed to select a lowest cost Energy Provider Billing Entity for the period of the power generation.

12. The EGR powered system of claim 9 comprising the blockchain wallet, wherein the blockchain wallet is uniquely associated with the EGR powered system and wherein the blockchain wallet is programmed to receive a value into the blockchain wallet.

13. The EGR powered system of claim 9 comprising one or more power generating components wherein the one or more power meters measure power generation of the one or more power generating components.

14. The EGR powered system of claim 9 configured to connect one or more second EGR powered systems comprising one or more power generating components, wherein the one or more power meters are configured to measure power generation of the one or more second EGR powered systems.

15. The EGR powered system of claim 9 wherein the one or more processors is programmed to generate a smart contract for the blockchain, wherein the smart contract indicates the EGR powered system blockchain wallet, a provider blockchain wallet associated with an Energy Provider Billing Entity, and the value.

16. A non-transitory computer readable medium comprising instructions, that when read by a processor, cause the processor to perform: calculating a cost of power generation for a EGR powered system, the EGR powered system comprising one or more power generating components that generate power to perform one or more intended functions of the EGR powered system, the EGR powered system associated with EGR powered system wallet; and an initiation of a transfer of a value for the cost of power generation for the EGR powered system from EGR powered system wallet 105 associated with the EGR powered system to a Energy Provider Billing Entity wallet 123 associated with an Energy Provider Billing Entity for the power generation.

17. The non-transitory computer readable medium of claim 16 wherein the instructions cause the processor to perform selecting an Energy Provider Billing Entity for the EGR powered system, and a cost rate of the energy charged by the Energy Provider Billing Entity.

18. The non-transitory computer readable medium of claim 16 wherein the EGR powered system blockchain wallet is uniquely associated to the EGR powered system.

19. The non-transitory computer readable medium of claim 16 wherein the blockchain wallet is programmed to receive a value into the blockchain wallet from EGR powered system wallet 105 of a purchaser of the EGR powered system.

20. The non-transitory computer readable medium of claim 16 wherein the instructions cause the processor to perform initiating the transfer by generating a smart contract for the blockchain, wherein the smart contract indicates the EGR powered system wallet, a Energy Provider Billing Entity wallet, and the value.
